(19) United States
(12) Patent Application Publication
(10) Pub. No.: US 2026/0307564 A1
(43) Pub. Date: Oct. 8, 2026

(54) SYSTEMS AND METHODS FOR LUMBAR SUPPORT IN A SEAT

(71) Applicant: GM GLOBAL TECHNOLOGY OPERATIONS LLC, Detroit, MI (US)

(72) Inventors: Yong-kyu Kim, Seo-gu (KR); Jongsuk An, Seo-gu (KR); Minsu Lee, Gyeonggi-do (KR)

(73) Assignee: GM GLOBAL TECHNOLOGY OPERATIONS LLC, Detroit, MI (US)

(21) Appl. No.: 19/169,521

(22) Filed: Apr. 3, 2025

(51) Int. Cl. B60N 2/66; B60N 2/02

(52) U.S. Cl. CPC B60N 2/66; B60N 2/0231

(57) ABSTRACT

Methods and systems are provided for lumbar support to an occupant of a seat. The systems include the seat having a seat cushion and a seatback that includes a frame, a lumbar support member disposed within the seatback that is coupled to the frame within and extending across the seatback, and that is configured to provide support to a lumbar region of a back of the occupant. The lumbar support member is elongated along a central, longitudinal axis thereof and has an axis of rotation that is parallel with but is not aligned with the central, longitudinal axis. The lumbar support member is configured to apply pressure to the back of the occupant with an intensity that is based on an angle of rotation of the lumbar support member. The system includes a motor configured for controllable rotation of the lumbar support member.

### INTRODUCTION

The technical field generally relates to vehicle seats, and more particularly relates to vehicle seats that include lumbar support systems.

Contemporary automobiles offer a range of amenities designed to enhance the comfort of their occupants. Examples of these features include adjustable seats that can be customized to accommodate specific occupants, including adjustments for seat height, recline angle, lumbar support, and headrest height.

However, there is an ongoing desire to provide systems and methods capable of further promoting occupant comfort while in a vehicle. Furthermore, other desirable features and characteristics of the present disclosure will become apparent from the subsequent detailed description and the appended claims, taken in conjunction with the accompanying drawings and the foregoing introduction.

### SUMMARY

A method is provided for lumbar support for an occupant of a seat. In one example, the method includes providing a seat having a seat cushion configured to support a rear of an occupant and a seatback configured to support a back of the occupant. The seatback includes a frame configured to provide structural support for the seatback, and a lumbar support member coupled to the frame within the seatback. The lumbar support member is elongated along a central, longitudinal axis thereof and extends across the seatback. The method includes rotating the lumbar support member in a manner configured to apply pressure to a lumbar region of the back of the occupant while the occupant is sitting on the seat, and rotating the lumbar support member in a manner configured to adjust the pressure applied thereby to the back of the occupant while the occupant is sitting on the seat. An axis of rotation of the lumbar support member is parallel with but is not aligned with the central, longitudinal axis thereof, and the lumbar support member is configured to apply pressure to the back of the occupant with an intensity that is based on an angle of rotation of the lumbar support member about the axis of rotation.

In various examples, the lumbar support member may have a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, the method including configuring the lumbar support member such that the axis of rotation is aligned with the first cross-sectional line of symmetry and offset from the second cross-sectional line of symmetry.

In various examples, the method may include coupling a shaft to the lumbar support member that includes a first member and a second member of the shaft with a flexible coupling disposed therebetween, wherein the flexible coupling provides for relative radial movement between the first member and the second member.

In various examples, the method may include continuously rotating the lumbar support member to provide a massage to the occupant therewith while the occupant is sitting on the seat.

In various examples, the method may include providing uniform pressure distribution along the lumbar support member for supporting the back of the occupant.

In various examples, the method may include providing elastic recovery and shape retention of the lumbar support member with a core thereof and providing energy absorption and gradual deformation in response to impact with an outer layer of the lumbar support member overlaying the core.

In various examples, the method may include controllably rotating the shaft via interaction with a user interface device, wherein the shaft is rotatable in two directions of rotation with the user interface device.

In various examples, the method may include installing the seat in a vehicle.

A system is provided for lumbar support for an occupant of a seat. In one example, the system includes a seat having a seat cushion configured to support an occupant sitting thereon and a seatback configured to support a back of the occupant while the occupant is sitting on the seat cushion. The seatback includes a frame configured to provide structural support for the seatback. The system includes a lumbar support member disposed within the seatback that is coupled to the frame within and extending across the seatback. The lumbar support member is configured to provide support to a lumbar region of a back of the occupant while sitting on the seat, the lumbar support member elongated along a central, longitudinal axis thereof and having an axis of rotation that is parallel with but is not aligned with the central, longitudinal axis. The lumbar support member is configured to apply pressure to the back of the occupant with an intensity that is based on an angle of rotation of the lumbar support member. The system includes a motor configured for controllable rotation of the lumbar support member.

In various examples, the lumbar support member may have a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry.

In various examples, the lumbar support member may be coupled to the frame with a shaft that extends through the lumbar support member, wherein the shaft includes a first member and a second member that are coupled by a flexible coupling configured to provide for relative radial movement between the first member and the second member, wherein the motor is configured to rotate the shaft and thereby rotate the lumbar support member.

In various examples, the motor may be configured to continuously rotate the lumbar support member to provide a massage to the occupant while the occupant is sitting on the seat.

In various examples, the lumbar support member may be configured to provide uniform pressure distribution therealong for supporting the back of the occupant while the occupant is sitting on the seat.

In various examples, the lumbar support member may include a core and an outer layer overlaying the core, wherein the core is configured to provide elastic recovery and shape retention, wherein the outer layer is configured to provide for energy absorption and gradual deformation in response to impact.

In various examples, the system may include a user interface device for operating the motor, wherein the motor is configured for controllable rotation of the lumbar support member in two directions of rotation.

In various examples, the seat may be configured to be installed in a vehicle, wherein the lumbar support member has a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry, wherein the lumbar support member is coupled to the frame with a shaft that extends through the lumbar support member, wherein the shaft includes a first member and a second member that are coupled by a flexible coupling configured to provide for relative radial movement between the first member and the second member, wherein the motor is configured to rotate the shaft and thereby rotate the lumbar support member, wherein the motor is configured to continuously rotate the lumbar support member to provide a massage to the occupant while the occupant is sitting on the seat, wherein the lumbar support member is configured to provide uniform pressure distribution therealong for supporting the back of the occupant while the occupant is sitting on the seat, wherein the system includes a user interface device for operating the motor, wherein the motor is configured for controllable rotation of the lumbar support member in two directions of rotation.

A vehicle is provided that, in one example, includes a seat having a seat cushion configured to support an occupant sitting thereon and a seatback configured to support a back of the occupant while the occupant is sitting on the seat cushion. The seatback includes a frame configured to provide structural support for the seatback. The vehicle includes a shaft rotatably coupled to the frame within and extending across the seatback, and a lumbar support member within the seatback configured to provide support to a lumbar region of a back of the occupant while sitting on the seat. The lumbar support member has a channel formed therethrough that is configured to receive the shaft, wherein rotation of the shaft causes rotation of the lumbar support member. The channel is elongated along a central, longitudinal axis thereof and has an axis of rotation that is parallel with but is not aligned with the central, longitudinal axis. The lumbar support member is configured to apply pressure to the back of the occupant with an intensity that is based on an angle of rotation of the shaft. The lumbar support member is configured to provide uniform pressure distribution therealong for supporting the back of the occupant. The vehicle includes a motor configured for controllable rotation of the shaft having the lumbar support member thereon and a user interface device for operating the motor.

In various examples, the lumbar support member may have a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry.

In various examples, the shaft may include a first member and a second member that are coupled by a flexible coupling configured to provide for relative radial movement between the first member and the second member, wherein the lumbar support member includes a core and an outer layer overlaying the core, wherein the core is configured to provide elastic recovery and shape retention, wherein the outer layer is configured to provide for energy absorption and gradual deformation in response to impact.

In various examples, the motor may be configured to continuously rotate the shaft to provide a massage to the occupant with the lumbar support member.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram of a vehicle having one or more seats with a lumbar support system in accordance with an example;

FIG. 2 is perspective view representing the lumbar support system of FIG. 1 as secured to a frame of one of the seats of FIG. 1 in accordance with an example;

FIG. 3 is a perspective, exploded view representing the components of the lumbar support system of FIGS. 1 and 2 in accordance with an example;

FIG. 4 is a cross-sectional view of a shaft and a lumbar support member of the lumbar support system of FIG. 2 along a line A-A in accordance with an example;

FIG. 5 is a perspective, cross-sectional view of an exemplary multi-layer lumbar support member for use with the lumbar support system of FIGS. 1-3 in accordance with an example;

FIG. 6 is a perspective view of an exemplary shaft assembly for use with the lumbar support system of FIGS. 1-3 in accordance with an example;

FIG. 7 is a partial side view of one of the seats of FIG. 1 with a detail view of a switch knob configured for control of the lumbar support system of FIGS. 1-3 in accordance with an example; and

FIG. 8 is a flowchart illustrating a method for providing lumbar support to an occupant of a seat in accordance with an example.

### DETAILED DESCRIPTION

The following detailed description is merely exemplary in nature and is not intended to limit the application and uses. Furthermore, there is no intention to be bound by any expressed or implied theory presented in the preceding introduction or the following detailed description.

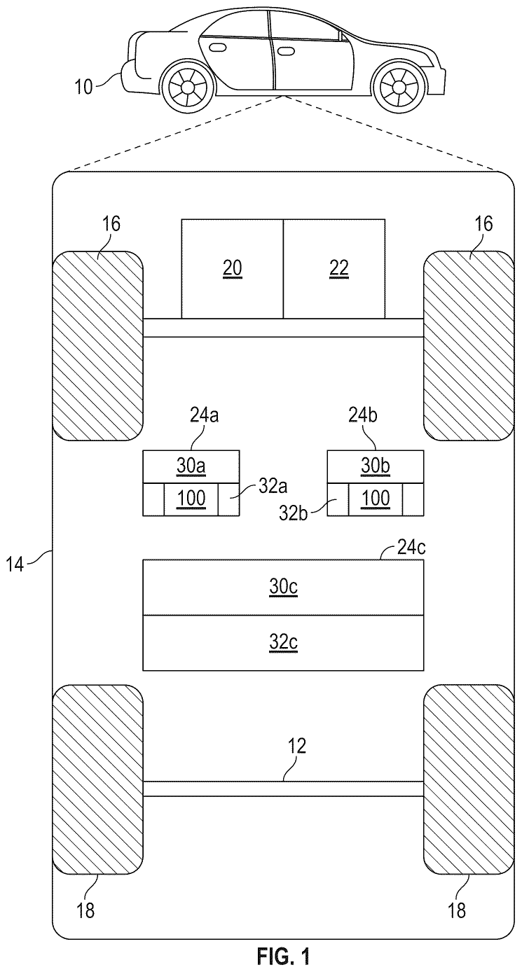

FIG. 1 illustrates a vehicle 10, according to an example. The vehicle 10 includes one or more seats having a lumbar support system 100 for waist or lower back support for occupants of the seats. In various examples, the vehicle 10 may be any one of a number of different types of automobiles, such as, for example, a sedan, a wagon, a truck, or a sport utility vehicle (SUV), and may be two-wheel drive (2WD) (i.e., rear-wheel drive or front-wheel drive), four-wheel drive (4WD) or all-wheel drive (AWD), and/or various other types of vehicles or mobile platforms in certain examples.

As depicted in FIG. 1, the exemplary vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16, 18 are each rotationally coupled to the chassis 12 near a respective corner of the body 14.

The vehicle 10 further includes a propulsion system 20, a transmission system 22, and seats 24 (identified as seats 24a, 24b, 24c in FIG. 1). The propulsion system 20 includes an engine and/or motor such as an internal combustion engine (e.g., a gasoline or diesel fueled combustion engine), an electric motor (e.g., a 3-phase AC motor), or a hybrid system that includes more than one type of engine and/or motor. The transmission system 22 is configured to transmit power from the propulsion system 20 to the wheels 16, 18 according to selectable speed ratios. According to various examples, the transmission system 22 may include a step-ratio automatic transmission, a continuously-variable transmission, or other appropriate transmission.

The seats 24 may include front seats 24a, 24b and one or more rear seats 24c each configured to support an occupant of the vehicle 10 sitting thereon. In this example, the vehicle 10 includes two rows of seats; however, the vehicle 10 may include one or more additional rows of seats such as a third row. Each of the seats 24 may include a frame (not shown) secured to a floor of the vehicle 10, a seat base or seat cushion 30 (identified as 30a-30c in FIG. 1) coupled to the frame, a seatback 32 (identified as 32a-32c in FIG. 1) secured at a lower end thereof to the seat cushion 30 and/or the frame, and a headrest secured to an upper end of the seatback 32. The seat cushion 30 may be configured to support a rear and/or thighs of the occupant seated thereon, the seatback 32 may be configured to support the occupant's back while seated on the seat cushion 30, and the headrest may be configured to support the occupant's head. The seats 24 may include various components that provide for adjustment thereof, such as systems for adjusting a height of the seats 24 relative to the vehicle floor, a recline angle of the seatback 32, and a height of the headrest relative to an upper end of the seatback 32.

One or more of the seats 24 include the lumbar support system 100 within the seatback 32 thereof that is configured to provide an occupant of the corresponding seat 24 with waist or lower back support having uniform pressure distribution across the seatback 32. In some examples, the lumbar support system 100 may be configured to provide adjustable pressure to the lumbar vertebrae of the occupant's back, such as the L3 to L5 region thereof. The lumbar support system 100 may be a two-way power lumbar support system intended to reduce the complexity of the lumbar support system relative to certain existing lumbar support systems for vehicle seats. Although the lumbar support system 100 is discussed herein in reference to the seats 24 of the vehicle 10, the lumbar support system 100 is not limited to such applications and may be use with other types of seats that are not installed within vehicles.

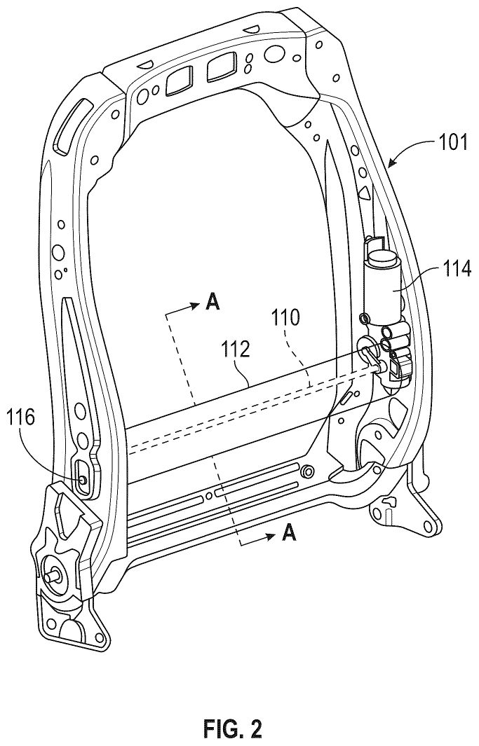

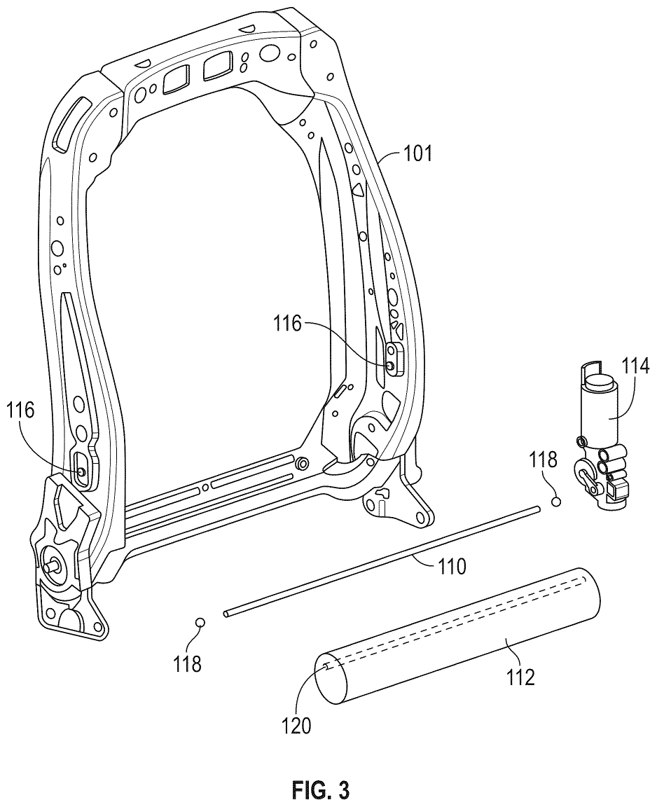

Referring to FIGS. 2 and 3, perspective views are provided to represent an example of the lumbar support system 100 as assembled and disassembled, respectively. For convenience, the lumbar support system 100 is described hereinafter as installed within the seatback 32a of the front seat 24a; however, as noted previously the lumbar support system 100 may be installed in one or more of the other seats 24b, 24c. In these figures, the lumbar support system 100 is described as coupled with a frame 101 that is configured to provide rigid structural support for the seatback 32a. It should be understood that the frame 101 is merely exemplary, and the lumbar support system 100 may be coupled with frames having other structures and configurations. Furthermore, other various components of the seatback 32a have been omitted for clarity of the description.

The lumbar support system 100 includes a shaft 110 rotatably coupled to the frame 101 within and extending across the seatback 32a, a lumbar support member 112 within the seatback 32a that is coupled to the shaft 110 and rotatable therewith, and a motor 114 coupled to the frame 101 within the seatback 32a that is configured for controllable rotation of the shaft 110 with the lumbar support member 112 thereon.

The shaft 110 may be rotatably coupled to oppositely disposed sides of the frame 101 at one or both ends of the shaft 110. For example, the ends of the shaft 110 may be rotatably coupled to aligned holes 116 in the sides of the frame 101. Shaft guides 118 may be disposed within the holes 116 between the frame 101 and the shaft 110 to provide for free rotation of the shaft 110 relative to the frame 101. In such examples, the shaft 110 may extend through an opening in the motor 114. Alternatively, one of the ends of the shaft 110 may be coupled to the motor 114 and thereby coupled to the frame 101 via the motor 114 at such end. The motor 114 may be various types of motors capable of rotating the shaft 110, such as a direct current (DC) motor operable via the DC terminal of the vehicle 10. In some examples, the motor 114 may be configured for controllable rotation of the shaft 110 in two directions of rotation. In some examples, the motor 114 may be configured to rotate the shaft 110 at two or more selectable speeds.

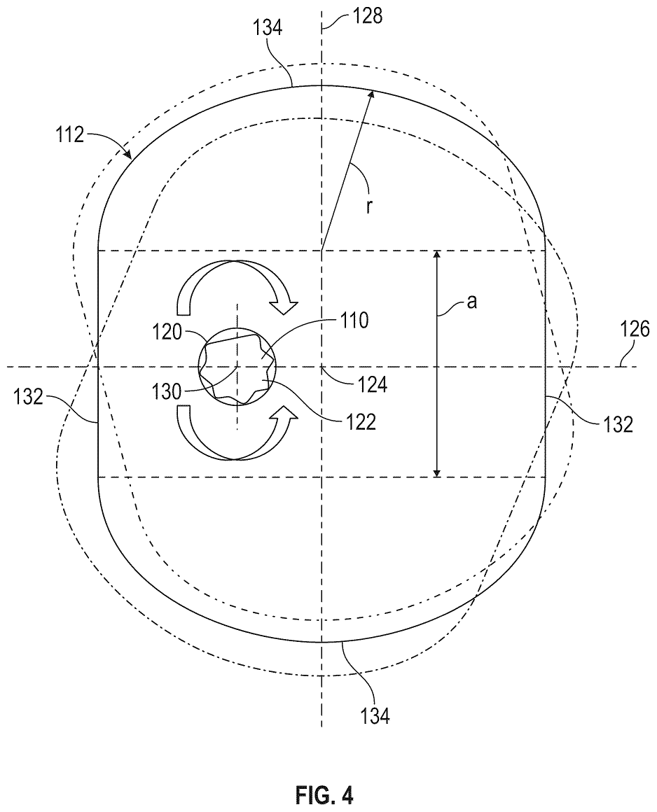

In this example, the lumbar support member 112 includes a channel 120 formed therethrough that is configured to receive the shaft 110. Once coupled to the shaft 110, the lumbar support member 112 may have a fixed position relative to the shaft 110 such that rotation of the shaft 110 causes rotation of the lumbar support member 112. In some examples, the shaft 110 and/or the channel 120 may include interface features that maintain the fixed relation between the positions of the shaft 110 and the lumbar support member 112 during rotation of the shaft 110. For example, FIG. 4 represents a cross-sectional view of the shaft 110 and the lumbar support member 112 taken along the line A-A of FIG. 2. As represented, the shaft 110 may include one or more teeth 122 extending radially therefrom that are configured to mate with interior surfaces of the channel 120 and thereby limit or prevent slippage between the shaft 110 and the lumbar support member 112.

The lumbar support member 112 may have various cross-sectional shapes including both symmetric and non-symmetric shapes. In the example of the figures, the lumbar support member 112 has a stadium cross-sectional shape defined by oppositely disposed, parallel straight sides 132 and oppositely disposed semicircular ends 134. The lumbar support member 112 has central, longitudinal axis 124, a first cross-sectional line of symmetry 126 that passes through the central, longitudinal axis 124 and bisects the straight sides 132, and a second cross-sectional line of symmetry 128 that passes through the central, longitudinal axis 124 and bisects the semicircular ends 134. The stadium cross-sectional shape of the lumbar support member 112 may be defined by the equation P=πr+a wherein a is a length of the sides 132 and r is a radius of the semicircular ends 134.

The lumbar support member 112 is elongated along an axis of rotation 130 at a cross-sectional center of the channel 120. In some examples, the axis of rotation 130 may be parallel with the central, longitudinal axis 124. In some examples, the axis of rotation 130 may oriented parallel to the seat cushion 30a or a component thereof. In some examples, the axis of rotation 130 may be offset from the central, longitudinal axis 124. In the example of the figures, the axis of rotation 130 is aligned with the first cross-sectional line of symmetry 126 and offset from the second cross-sectional line of symmetry 128, as represented in FIG. 4. In other examples, the axis of rotation 130 may be offset from the first cross-sectional line of symmetry 126 and aligned with the second cross-sectional line of symmetry 128. In yet other examples, the axis of rotation 130 may be offset from both the first and second cross-sectional lines of symmetry 126, 128.

With the arrangement described herein, an intensity or value of the pressure applied to the occupant's back is based on an angle of rotation of the shaft 110. For example, because of the non-circular cross-sectional shape of the lumbar support member 112, a dimension between the axis of rotation 130 and the outermost extent of the lumbar support member 112 in the direction of the occupant will vary depending on the angle of rotation. For example, if the axis of rotation 130 were to be aligned with the central, longitudinal axis 124, the pressure applied to the occupant's back would be the greatest when either of the semicircular ends 134 is directed toward the occupant's back, and would be the least when either of the sides 132 is directed toward the occupant's back.

Offsetting the axis of rotation 130 from the central, longitudinal axis 124 may provide additional possible lumbar support pressures that may be applied to the back of the occupant. For example, offsetting the axis of rotation 130 from the first line of symmetry 126 causes the ends 134 to apply different pressures, and offsetting the axis of rotation 130 from the second line of symmetry 128 causes the sides 132 to apply different pressures. In the example of FIG. 4, the ends 134 provide equal pressure to each other since the dimensions between the perimeters thereof and the axis of rotation 130 are equal (i.e., 1/2a+r). However, since the dimensions between each of the sides 132 and the axis of rotation 130 are different, the sides 132 provide different pressures than each other. In FIG. 4, dashed lines are provided that represent exemplary positions of the outer surfaces of the lumbar support member 112 at different degrees of rotation.

In some examples, the cross-sectional shape of the lumbar support member 112 may be uniform along the central, longitudinal axis 124 to provide uniform pressure distribution therealong for supporting the back of the occupant. Stated another way, the dimension between the axis of rotation 130 and the outermost surface of the lumbar support member 112 is equal along the longitudinal length of the lumbar support member 112 for each degree of rotation of the shaft 110. As a specific example, in FIG. 4, a dimension 1/2a+r is the same along the entire longitudinal length of the lumbar support member 112.

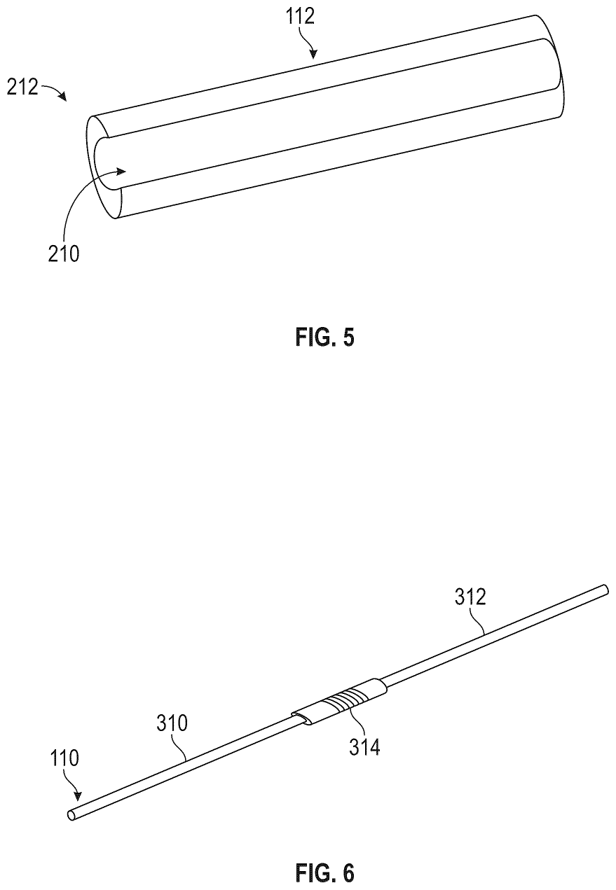

The lumbar support member 112 may include a single, uniform or integral body, or alternatively may include a body defined by two or more layers. For example, FIG. 5 represents a cross-sectional view of the lumbar support member 112 in accordance with an example that includes an inner layer or core 210 encased in an outer layer 212. The channel 120 has been omitted for clarity. In this two layer example, the core 210 and the outer layer 212 may be configured to provide different functions or properties for the lumbar support member 112. For example, the core 210 and the outer layer 212 may be formed of or include different materials that have different properties (e.g., rigidity, compression, etc.). In some examples, the core 210 may be configured to promote energy absorption and gradual deformation under impact, and the outer layer 212 may be configured to promote elastic recovery and shape retention. In such examples, the core 210 may be formed of a memory foam material and the outer layer 212 may be formed of a thermoplastic elastomer.

In some examples, the shaft 110 may include a single, uniform or integral body, or may include an assembly including by two or more separate members coupled to each other. For example, FIG. 6 represents a perspective view of the shaft 110 in accordance with an example that includes first and second members 310, 312 that are coupled at distal ends thereof with a coupling 314. In this example, the coupling 314 is a flexible coupling (e.g., spring coupling) configured to allow the shaft 110 to be more flexible and provide for relative radial movement between the first member 310 and the second member 312 during use of the lumbar support system 100. Such relative radial movement may be provided, for example, to compensate for tension toward a rear of the shaft 110 during use thereof (i.e., applying pressure to an occupant's back). The shaft 110 and/or members thereof may be formed of various materials such as, but not limited to, certain metallic materials. In some examples, the shaft 110 and/or members thereof may be formed of a spring steel such as SAE grade 1070, 1074, 1080, 1095, 5160, 50CrV4, 9255, or 301.

In some examples, the lumbar support system 100 may be configured to operate in more than one mode and/or to provide more than one feature. For example, the motor 114 may be configured to rotate the shaft 110 continuously to provide a massage to the occupant with the lumbar support member 112. If the motor 114 is capable of rotation of the shaft 110 at more than one speed, the rotational speed may be selectable by the occupant to adjust the intensity of the massage. In some examples, the lumbar support system 100 may be configured to provide the massage for a predetermined period of time (e.g., one minute), for a period of time that is selectable or programable by the occupant, or continuously until the occupant cancels the massage.

The lumbar support system 100 may include various user interfaces, devices, and/or systems for adjusting the pressure applied by the lumbar support member 112, and the lumbar support system 100 is not limited to any particular type of user interface, device, or control method. In some examples, the lumbar support system 100 may include a physical know, button, switch, or similar device for manually controlling operation of the motor 114 and thereby controlling rotation of the lumbar support member 112. In other examples, the lumbar support system 100 may be operated via a digital graphic user interface displayed on, for example, a touchscreen device. In some examples, the lumbar support system 100 may be operated at least in part by a software algorithm.

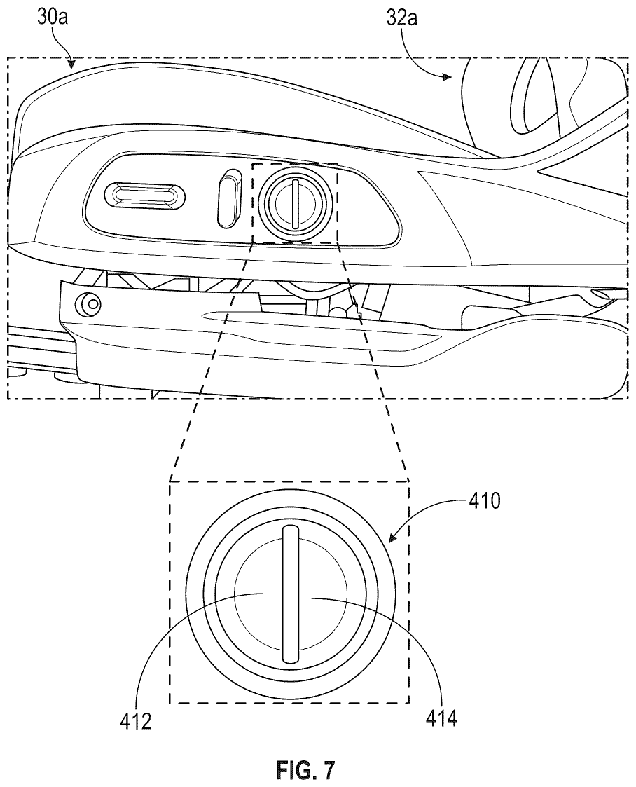

FIG. 7 represents an exemplary switch knob 410 located on a side of the seat cushion 30a. The occupant of the seat 24a may interact with the switch knob 410 to manually control some or all aspects of the lumbar support system 100. For example, the occupant may press a first surface 412 of the switch knob 410 once to initiate rotation of the shaft 110 in a first direction, and press the first surface 412 twice to initiate rotation of the shaft 110 in an opposite second direction. In some examples, pressing the first surface 412 may cause the motor 114 to rotate the shaft 110 a predetermined number of degrees. In other examples, the occupant may press and hold the first surface 412 to continuously rotate the shaft 110 and release the first surface 412 as desired to cease rotation of the shaft 110.

In some examples wherein the lumbar support system 100 is configured to provide the massage feature, the occupant may press a second surface 414 once to initiate continuous rotation in the first direction, and press the second surface 414 twice to initiate continuous rotation in the second direction. In some examples, the occupant may interact with the switch knob 410 to cancel the massage and cease rotation of the shaft 110.

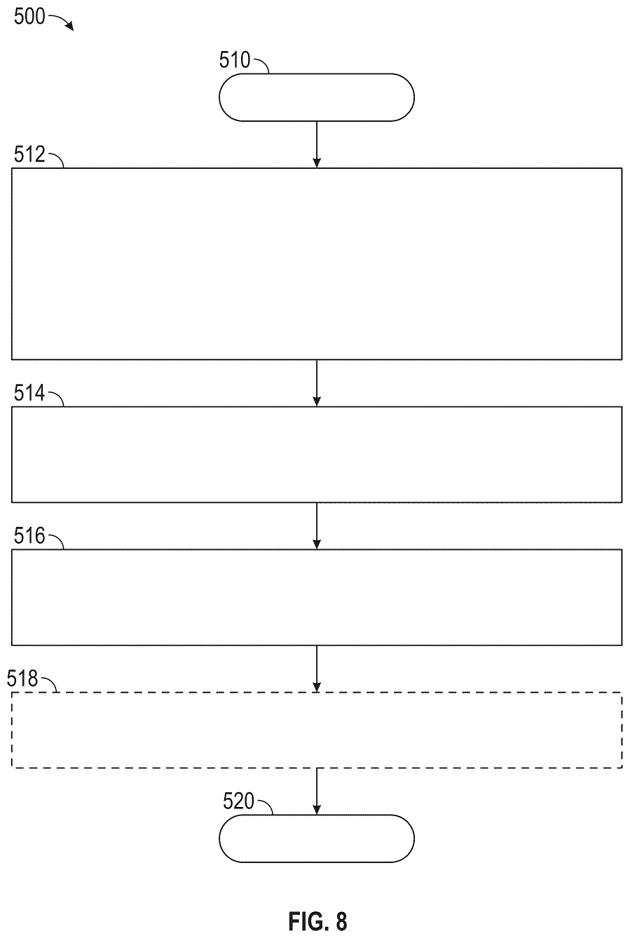

With reference now to FIG. 8 and with continued reference to FIGS. 1-7, a flowchart provides a method 500 for providing lumbar support to an occupant of a seat, for example, as performed by the lumbar support system 100, in accordance with various examples. As can be appreciated in light of the disclosure, the order of operation within the method 500 is not limited to the sequential execution as illustrated in FIG. 8, but may be performed in one or more varying orders as applicable and in accordance with the present disclosure.

In one example, the method 500 may start at 510. At 512, the method 500 may include providing a seat having a seat cushion configured to support a rear of an occupant and a seatback configured to support a back of the occupant. The seatback includes a frame configured to provide structural support for the seatback, and a lumbar support member coupled to the frame within the seatback. The lumbar support member is elongated along a central, longitudinal axis thereof and extends across the seatback. At 514, the method 500 may include rotating the lumbar support member in a manner configured to apply pressure to a lumbar region of the back of the occupant while the occupant is sitting on the seat. At 516, the method 500 may include rotating the lumbar support member in a manner configured to adjust the pressure applied thereby to the back of the occupant while the occupant is sitting on the seat. At 518, the method 500 may optionally include continuously rotating the shaft to provide a massage to the back of the occupant with the lumbar support member. The method 500 may end at 520.

The systems and methods disclosed herein provide various benefits over certain existing systems and methods. For example, the lumbar support system may provide support for an occupant's lower back in a uniform and easy to operate manner. In some examples, the lumbar support system may require fewer components, may be easier to manufacture, and may be more reliable that certain existing lumbar support systems. Further, the lumbar support system may provide the additional function of performing massages on the occupant.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method, comprising:
providing a seat having a seat cushion configured to support a rear of an occupant and a seatback configured to support a back of the occupant, wherein the seatback includes a frame configured to provide structural support for the seatback, and a lumbar support member coupled to the frame within the seatback, wherein the lumbar support member is elongated along a central, longitudinal axis thereof and extends across the seatback;
rotating the lumbar support member in a manner configured to apply pressure to a lumbar region of the back of the occupant while the occupant is sitting on the seat; and
rotating the lumbar support member in a manner configured to adjust the pressure applied thereby to the back of the occupant while the occupant is sitting on the seat,
wherein an axis of rotation of the lumbar support member is parallel with but is not aligned with the central, longitudinal axis thereof, and the lumbar support member is configured to apply pressure to the back of the occupant with an intensity that is based on an angle of rotation of the lumbar support member about the axis of rotation.

2. The method of claim 1, wherein the lumbar support member has a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, the method including configuring the lumbar support member such that the axis of rotation is aligned with the first cross-sectional line of symmetry and offset from the second cross-sectional line of symmetry.

3. The method of claim 1, further comprising coupling a shaft to the lumbar support member that includes a first member and a second member of the shaft with a flexible coupling disposed therebetween, wherein the flexible coupling provides for relative radial movement between the first member and the second member.

4. The method of claim 1, further comprising continuously rotating the lumbar support member to provide a massage to the occupant therewith while the occupant is sitting on the seat.

5. The method of claim 1, further comprising providing uniform pressure distribution along the lumbar support member for supporting the back of the occupant.

6. The method of claim 1, further comprising providing elastic recovery and shape retention of the lumbar support member with a core thereof and providing energy absorption and gradual deformation in response to impact with an outer layer of the lumbar support member overlaying the core.

7. The method of claim 1, further comprising controllably rotating the shaft via interaction with a user interface device, wherein the shaft is rotatable in two directions of rotation with the user interface device.

8. The method of claim 1, further comprising installing the seat in a vehicle.

9. A system, comprising:
a seat having a seat cushion configured to support an occupant sitting thereon and a seatback configured to support a back of the occupant while the occupant is sitting on the seat cushion, wherein the seatback includes a frame configured to provide structural support for the seatback;
a lumbar support member disposed within the seatback that is coupled to the frame within and extending across the seatback, wherein the lumbar support member is configured to provide support to a lumbar region of a back of the occupant while sitting on the seat, the lumbar support member elongated along a central, longitudinal axis thereof and having an axis of rotation that is parallel with but is not aligned with the central, longitudinal axis, wherein the lumbar support member is configured to apply pressure to the back of the occupant with an intensity that is based on an angle of rotation of the lumbar support member; and
a motor configured for controllable rotation of the lumbar support member.

10. The system of claim 9, wherein the lumbar support member has a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry.

11. The system of claim 9, wherein the lumbar support member is coupled to the frame with a shaft that extends through the lumbar support member, wherein the shaft includes a first member and a second member that are coupled by a flexible coupling configured to provide for relative radial movement between the first member and the second member, wherein the motor is configured to rotate the shaft and thereby rotate the lumbar support member.

12. The system of claim 9, wherein the motor is configured to continuously rotate the lumbar support member to provide a massage to the occupant while the occupant is sitting on the seat.

13. The system of claim 9, wherein the lumbar support member is configured to provide uniform pressure distribution therealong for supporting the back of the occupant while the occupant is sitting on the seat.

14. The system of claim 9, wherein the lumbar support member includes a core and an outer layer overlaying the core, wherein the core is configured to provide elastic recovery and shape retention, wherein the outer layer is configured to provide for energy absorption and gradual deformation in response to impact.

15. The system of claim 9, further comprising a user interface device for operating the motor, wherein the motor is configured for controllable rotation of the lumbar support member in two directions of rotation.

16. The system of claim 9, wherein the seat is configured to be installed in a vehicle, wherein the lumbar support member has a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry, wherein the lumbar support member is coupled to the frame with a shaft that extends through the lumbar support member, wherein the shaft includes a first member and a second member that are coupled by a flexible coupling configured to provide for relative radial movement between the first member and the second member, wherein the motor is configured to rotate the shaft and thereby rotate the lumbar support member, wherein the motor is configured to continuously rotate the lumbar support member to provide a massage to the occupant while the occupant is sitting on the seat, wherein the lumbar support member is configured to provide uniform pressure distribution therealong for supporting the back of the occupant while the occupant is sitting on the seat, wherein the system includes a user interface device for operating the motor, wherein the motor is configured for controllable rotation of the lumbar support member in two directions of rotation.

17. A vehicle, comprising:
a seat having a seat cushion configured to support an occupant sitting thereon and a seatback configured to support a back of the occupant while the occupant is sitting on the seat cushion, wherein the seatback includes a frame configured to provide structural support for the seatback;
a shaft rotatably coupled to the frame within and extending across the seatback;
a lumbar support member within the seatback configured to provide support to a lumbar region of a back of the occupant while sitting on the seat, the lumbar support member having a channel formed therethrough that is configured to receive the shaft, wherein rotation of the shaft causes rotation of the lumbar support member, wherein the channel is elongated along a central, longitudinal axis thereof and has an axis of rotation that is parallel with but is not aligned with the central, longitudinal axis, wherein the lumbar support member is configured to apply pressure to the back of the occupant with an intensity that is based on an angle of rotation of the shaft, wherein the lumbar support member is configured to provide uniform pressure distribution therealong for supporting the back of the occupant;
a motor configured for controllable rotation of the shaft having the lumbar support member thereon; and
a user interface device for operating the motor.

18. The vehicle of claim 17, wherein the lumbar support member has a stadium cross-sectional shape defined by oppositely disposed, parallel straight sides and oppositely disposed semicircular ends, wherein the lumbar support member has a first cross-sectional line of symmetry that bisects the straight sides and a second cross-sectional line of symmetry that bisects the semicircular ends, wherein the axis of rotation is aligned with the first cross-sectional line of symmetry and offset from the second cross-sectional line of symmetry.

19. The vehicle of claim 17, wherein the shaft includes a first member and a second member that are coupled by a flexible coupling configured to provide for relative radial movement between the first member and the second member, wherein the lumbar support member includes a core and an outer layer overlaying the core, wherein the core is configured to provide elastic recovery and shape retention, wherein the outer layer is configured to provide for energy absorption and gradual deformation in response to impact.

20. The vehicle of claim 17, wherein the motor is configured to continuously rotate the shaft to provide a massage to the occupant with the lumbar support member.
